(19) United States
(12) Patent Application Publication
(10) Pub. No.: US 2005/0265201 A1
(43) Pub. Date: Dec. 1, 2005

(54) Integrated type light-emitting and light-receiving element, optical pickup device for optical information medium and optical disc apparatus

(75) Inventor: Tadashi Taniguchi, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 11/127,221

(22) Filed: May 12, 2005

(30) Foreign Application Priority Data
May 25, 2004 (JP) P2004-154804
Apr. 14, 2005 (JP) P2005-117362

(51) Int. Cl. G11B 7/00; G11B 7/135

(52) U.S. Cl. 369/110.01; 369/110.04; 369/112.01; 369/44.23

(57) ABSTRACT

An integrated type light-emitting and light-receiving element includes a polarizing hologram and this polarizing hologram introduces returned light into a second photo-detecting unit for detecting an RF information signal independently of a first photo-detecting unit into which returned light is introduced through a micro-prism, whereby the number of amplifiers in a detecting unit for detecting the RF information signal can be decreased and an S/N (signal-to-noise ratio) or a C/N (carrier-to-noise ratio) of the RF information signal can be improved.

### CROSS REFERENCES TO RELATED APPLICATIONS

The present invention contains subject matter related to Japanese Patent Application JP 2004-154804 filed in the Japanese Patent Office on May 25, 2004, and Japanese Patent Application JP 2005-117362 filed in the Japanese Patent Office on Apr. 14, 2005, the entire contents of which being incorporated herein by reference.

### BACKGROUND OF THE INVENTION

1. Field of the Invention

The present invention relates to an integrated type light-emitting and light-receiving element, an optical pickup device for use with an optical information medium and an optical disc apparatus.

2. Description of the Related Art

An optical pickup device is able to record and reproduce an optical information medium, for example, an optical disc, and this optical pickup device having an integrated type light-emitting and light-receiving element (so-called laser coupler) in which an element for emitting reproducing laser light and an element for detecting returned light are integrated as one body is now commercially available. Also, a large number of optical pickup devices using a laser coupler as such integrated type light-emitting and light-receiving element are proposed (see Cited Patent References 1 and 2, for example).

FIG. 1 of the accompanying drawings is a schematic diagram showing a fundamental arrangement of an example of an optical pickup device including a polarizing optical system for use with an optical information medium 1, for example, an optical disc. As shown in FIG. 1, this optical pickup device includes a polarizing optical system composed of a laser coupler 20, an objective lens 3 and a quarter-wave plate 4, for example.

This laser coupler 20 has a light emitting function to emit laser light LF to illuminate the optical information medium 1 and a detecting function to detect returned light LB of this laser light LF from the optical information medium 1 to generate data recorded information on the optical information medium 1 and servo signals such as a focusing error signal and a tracking error signal.

More specifically, as shown in FIG. 1, this laser coupler 20 includes a light source unit 5 for emitting the illumination light LF, a micro-prism 5 and a photo-detecting unit 7 for detecting the returned light LB from the optical information medium 1.

The micro-prism 6 includes an inclined polarizing light reflecting face 9 for efficiently reflecting first linearly-polarized laser light LF of S-polarized light or P-polarized light from the light source unit 5 and which efficiently passes incident light of returned light LB of second linearly-polarized light of P-polarized light or S-polarized light different from the linearly-polarized light LF and which is polarized on the plane of polarization.

On the other hand, the photo-detecting unit 7 includes first and second photo-detecting element units PD1 and PD2, each of which is formed of a photo-diode, disposed with a predetermined space. The first and second photo-detecting element units PD1 and PD2 are assembled into a semiconductor integrated circuit (IC) 8 and located under the micro-prism 6.

Then, a part of the returned light LB is introduced from the inclined polarized light reflecting face 9 of the micro-prism 6 into the first photo-detecting element portion PD1, in which it is converted into an electric signal and thereby detected. A rest of light is reflected on the micro-prism 6 at its upper surface opposite to the side in which the photo-detecting unit 7 is located and it is introduced into the second photo-detecting element portion PD2, in which it is converted into an electric signal and thereby detected.

Those first and second photo-detecting element units PD1 and PD2 are composed of divided photo-diodes, respectively. The first and second photo-detecting element units PD1 and PD2 convert returned lights, introduced into the respective divided photo-diodes, into electric signal to generate electric current signals.

Then, the photo-detecting unit 7 calculates these detected signals to generate the focusing error signal and the tracking error signal. On the other hand, data information recorded on the optical information medium 1, that is, high frequency information signal, that is, so-called RF signal is obtained by calculating the total sum of the respective electric current signals from the respective divided photo-diodes of the above-mentioned first and second photo-detecting element units PD1 and PD2 after the respective electric current signals were amplified by amplifiers.

However, when such optical pickup device is applied to an optical pickup device for use with a high-density recording medium, that is, optical disc which is what might be called a Blu-ray Disc (BD) using laser light with a short wavelength, that is, a wavelength of 405 nm, a problem of a noise of RF signal arises.

The noise of this RF signal will be described below. That is, when very small electric current signals obtained from the divided photo-diodes comprising the first and second photo-detecting element units PD1 and PD2 are amplified by amplifiers, the thus amplified electric current signals are separately converted in the form of current-to-voltage (I-V conversion) and they are added as the total sum, the amount of random noises becomes square root times of the number N of amplifiers for adding the voltage signals, that is, N times. For example, when the RF signal is received by one photo-diode PD and it is converted in the form of current-to-voltage (I-V conversion), when the RF signal is received by a quadrant photo-diode PD, converted in the form of current-to-voltage (I-V conversion) and then added, amplifier noise of which amount is 0.4=2 times is superimposed upon the RF signal.

Further, there has been proposed a drive apparatus using a common optical pickup device having different wavelengths of available laser lights and different numerical apertures NA of objective lenses and which is common to more than two kinds of optical information mediums, for example, more than two kinds of optical information mediums such as a CD (Compact Disc), a DVD (Digital Versatile Disc) and BD (Blu-ray Disc). In this case, with respect to the tracking error signal detection method, since suitable detection methods are applied to arrangements of respective optical information mediums, the divided number of the divided photo-diodes is unavoidably increased and hence the influence exerted upon the RF signal from the above-mentioned amplifier noise becomes serious.

FIGS. 2A to 2D show patterns of divided photo-diodes comprising the above-mentioned first and second photo-detecting element units PD1 and PD2, respectively. FIG. 2A shows a divided pattern in an SSD (Spot Size Detection) system for detecting a focusing error. In this case, as shown in FIG. 2A, the first and second photo-detecting element units PD1 and PD2 need six-divided arrangements, each composed of trisected photo-diode portions AA1, AB1, AC2 and AA2, AB2, AC2. Then, a focusing error signal can be obtained by calculating difference between a sum of outputs from the photo-diode portions AA1, AC1, AB2 and a sum of outputs from the photo-diode portions AA2, AC2, AB1.

On the other hand, a tracking error is detected from a CD, a rewritable disc (RW-disc), for example, a phase-change disc by a push-pull system. Specifically, in this case, as shown in FIG. 2B, the first and second photo-detecting element units PD1 and PD2 need bisected arrangements, each composed of photo-diode portions BA1, BB1 and BA2, BB2. Then, a tracking error signal can be obtained by calculating a difference between a sum of the detected outputs from the photo-diode portions BA1 and BB2 and a sum of the detected outputs from the photo-diode portions BB1 and BA2.

Also, with respect to the DVD and the BD, there is used a tracking error detection method based on a DPD (Differential Phase Detection) system, for example. In this case, as shown in FIG. 2C, the first photo-detecting unit PD1 has a quadrant arrangement composed of photo-diode portions CA1, BB1, CC1 and CD1.

Then, a tracking error signal may be obtained by phase-comparing sums of the detected outputs from the photo-diode portions CA1, CC1 and the detected outputs from the photo-diode portions BB1 and CD1.

Accordingly, as shown in FIG. 2D, the photo-detecting unit 7 having 12-divided arrangements is used to construct an arrangement which can combine the above-mentioned photo-diodes on the whole. As a result, the above-mentioned amplifier noise becomes extremely large. In particular, when the short wavelength laser light for the above-mentioned BD is in use, a problem arises in an S/N (signal-to-noise ratio) or a C/N (carrier-to-noise ratio) in a rewritable disc having a rewritable arrangement.

[Cited Patent Reference 1]: Official Gazette of Japanese laid-open patent application No. 10-289474

[Cited Patent Reference 2]: Official Gazette of Japanese laid-open patent application No. 11-45448

### SUMMARY OF THE INVENTION

In view of the aforesaid aspects, the present invention intends to provide an integrated type light-emitting and light-receiving element, an optical pickup device for use with an optical information medium and an optical disc apparatus in which an S/N (signal-to-noise ratio) of a reproduced signal can be increased by effectively improving a problem of a noise in the above-mentioned high frequency information signal (RF signal).

According to an aspect of the present invention, there is provided an integrated type light-emitting and light-receiving element which is comprised of a light source unit for emitting laser light of first linearly-polarized light of S-polarized wave or P-polarized wave, a prism, at least first and second laser light detecting units and a polarizing hologram, the first and second laser light detecting units and the polarizing hologram being integrated with each other as one body, wherein the prism has an inclined polarized light reflecting face for reflecting the first linearly-polarized laser light from the light source unit and which passes second linearly-polarized light of P-polarized wave or S-polarized wave different from the first linearly-polarized laser light, the polarizing hologram does not generate diffracted light for the first linearly-polarized laser light and which generates diffracted light for the second linearly-polarized laser light, any one of diffracted lights of zero-th order light and diffracted light of low-order greater than first-order is introduced through the prism into the first laser light detecting unit and the other is introduced into said second laser light detecting unit and thereby lights are detected.

In the above-mentioned integrated type light-emitting and light-receiving element according to the present invention, the first photo-detecting unit is a photo-detecting unit for generating a control signal to control illumination of the emitted laser light on an irradiated portion and the second photo-detecting unit is a photo-detecting unit for generating a high frequency information signal of returned light independently of the control signal.

In the above-mentioned integrated type light-emitting and light-receiving element according to the present invention, the first photo-detecting unit detects zero-th order light after the zero-th order light was introduced from the polarizing hologram into the prism and the second photo-detecting unit detects first-order diffracted light from the hologram.

In the above-mentioned integrated type light-emitting and light-receiving element according to the present invention, the polarizing hologram includes a blazed polarizing hologram.

In the above-mentioned integrated type light-emitting and light-receiving hologram according to the present invention, the first and second photo-detecting units are assembled into one semiconductor integrated circuit.

In the above-mentioned integrated type light-emitting and light-receiving element according to the present invention, the prism and the first and second laser light detecting units are located within a package, the polarizing hologram being located at the position serving as a light path through which laser light is introduced into and outputted from the package.

According to other aspect of the present invention, there is provided an optical pickup device for use with an optical information medium. This optical pickup device is comprised of an objective lens, an integrated type light-emitting and light-receiving element and a polarizing optical system for polarizing linearly-polarized laser light from the integrated type light-emitting and light-receiving element to provide different polarized lights depending on an inward path and an outward path of emitted light to and from the optical information medium, wherein the integrated type light-emitting and light-receiving element includes a light source unit for emitting first linearly-polarized light of S-wave or P-wave, a prism, first and second laser light detecting units and a polarizing program, the prism includes an inclined polarized light reflecting face for reflecting the first linearly-polarized laser light emitted from the light source unit and which passes incident light of second linearly-polarized light of polarized P-wave or S-wave different from the linearly-polarized laser light, the polarizing hologram is a polarizing hologram which does not generate diffracted light relative to the first linearly-polarized laser light and which generates diffracted light relative to the second linearly-polarized light of the inward path and the laser light detecting unit includes a first photo-detecting unit for detecting returned light of any of zero-th order light and diffracted light of low-order greater than first-order of the second linearly-polarized light from the polarizing hologram and which is introduced into the prism and a second photo-detecting unit disposed outside the prism for detecting low-order diffracted light greater than the first-order or zero-th order light from the polarizing hologram.

In the above-mentioned optical pickup device for use with an optical information medium according to the present invention, the first photo-detecting unit is a photo-detecting unit for generating a control signal to control irradiation of the emitted laser light on an irradiated portion and the second photo-detecting unit is a photo-detecting unit for generating a high frequency information signal of the returned light independently of the control signal.

In the above-mentioned optical pickup device for use with an optical information medium according to the present invention, the zero-th order light from the polarizing hologram is introduced into the prism and detected by the first photo-detecting unit and the first-order light from the polarizing hologram is detected by the second photo-detecting unit.

In the above-mentioned optical pickup device for use with an optical information medium according to the present invention, the polarizing hologram includes a blazed polarizing hologram.

In the above-mentioned optical pickup device for use with an optical information medium according to the present invention, the first and second photo-detecting units are assembled into one semiconductor integrated circuit.

In the above-mentioned optical pickup device for use with an optical information medium according to the present invention, the light source unit, the prism and the first and second laser light detecting units are located within a package and the polarizing hologram is located at the position serving as a light path through which laser light is introduced into and outputted from the package.

In accordance with a further aspect of the present invention, there is provided an optical disc apparatus which is comprised of a mount portion in which an optical disc is mounted, an objective lens, an integrated type light-emitting and light-receiving element and a polarizing optical system for polarizing emitted light of linearly-polarized laser light from the integrated type light-emitting and light-receiving element to provide different polarized lights depending on an outward path and an inward path of emitted light to and from an optical information medium, wherein the integrated type light-emitting and light-receiving element includes a light source unit for emitting first linearly-polarized light of S-wave or P-wave, a prism, first and second laser light detecting units and a polarizing program, the prism includes an inclined polarized light reflecting face for reflecting the first linearly-polarized laser light emitted from the light source unit and which passes incident light of second linearly-polarized light of polarized P-wave or S-wave different from the linearly-polarized laser light, the polarizing hologram is a polarizing hologram which does not generate diffracted light relative to the first linearly-polarized laser light and which generates diffracted light relative to the second linearly-polarized light of the inward path and the laser light detecting unit includes a first photo-detecting unit for detecting returned light of any of zero-th order light and diffracted light of low-order greater than first-order of the second linearly-polarized light from the polarizing hologram and which is introduced into the prism and a second photo-detecting unit disposed outside the prism for detecting low-order diffracted light greater than the first-order or zero-th order light from the polarizing hologram.

In the above-mentioned optical disc apparatus according to the present invention, the first photo-detecting unit is a photo-detecting unit for generating a control signal to control irradiation of the emitted laser light on an irradiated portion and the second photo-detecting unit is a photo-detecting unit for generating a high frequency information signal of the returned light independently of the control signal.

In the above-mentioned optical disc apparatus according to the present invention, the zero-th order light from the polarizing hologram is introduced into the prism and detected by the first photo-detecting unit and the first-order light from the polarizing hologram is detected by the second photo-detecting unit.

In the above-mentioned optical disc apparatus according to the present invention, the polarizing hologram includes a blazed polarizing hologram.

Further, in the above-mentioned optical disc apparatus according to the present invention, the first and second photo-detecting units are assembled into one semiconductor integrated circuit.

Furthermore, in the above-mentioned optical disc apparatus according to the present invention, the light source unit, the prism and the first and second laser light detecting units are located within a package and the polarizing hologram is located at the position serving as a light path through which laser light is introduced into and outputted from the package.

The above-mentioned integrated type light-emitting and light-receiving element according to the present invention can detect light introduced into the prism and it includes the polarizing hologram to generate diffracted light in returned light of predetermined polarized light introduced into the prism so that light path separated from light other than light introduced into the prism, for example, zero-th order light.

As described above, since zero-th order light, for example, passed through the polarizing hologram is introduced through the inclined polarized light reflecting face of the prism into the prism, predetermined information is detected by the first photo-detecting unit, for example, and diffracted light generated by the polarizing hologram is independently detected by the second photo-detecting unit and thereby predetermined information can be obtained, information can be independently obtained by the first and second photo-detecting units, and hence predetermined information of low noise independent of the first photo-detecting unit can be detected from the second photo-detecting unit, for example.

Then, according to the optical pickup device using the above-mentioned integrated type light-emitting and light-receiving element according to the present invention, laser light of S-wave or P-wave from the integrated type light-emitting and light-receiving element is irradiated on the target optical information medium, for example, the optical disc. When P-wave or S-wave of the returned light is passed through the polarizing hologram, zero-th order light and first-order light are generated and one of the two lights, for example, zero-th order light is introduced through the inclined polarized light reflecting face through the prism and the information signal for controlling illumination of laser light on the optical information medium, for example, the focusing error signal and the tracking error signal can be obtained by the first photo-detecting unit.

Then, laser light of other light path generated by the polarizing hologram is received by the second photo-detecting unit, whereby the RF signal can be obtained independently of the above-mentioned focusing error signal and tracking error signal.

Accordingly, with respect to this RF signal, since its output is amplified by the single amplifier, even when the first photo-detecting unit, for example, includes a number of divided photo-diode portions, it is possible to decrease the noise of the aforementioned amplifier.

Therefore, even when the optical pickup device includes a large number of divided photo-diode portions in order to detect tracking error signals suitable for various kinds of optical information mediums as was already described with reference to FIGS. 2A to 2D, without being affected by the amplifier noise, it is possible to obtain the high frequency information signal, that is, RF signal with low noise, accordingly, whose S/N (C/N) can be improved.

Then, since the optical pickup device according to the present invention includes the blazed polarizing hologram as the polarizing hologram of the integrated type light-emitting and light-receiving element, only any one of positive (+) and negative (−) diffracted lights can be obtained and hence intensity of diffracted light can be increase. Accordingly, if diffracted light of low order, for example, zero-th order light from the blazed polarizing hologram is used, then light with sufficiently large quantity of light can be detected and hence it is possible to increase an amount of signal to be obtained.

### BRIEF DESCRIPTION OF THE DRAWINGS

FIG. 1 is a schematic diagram showing an arrangement of an optical pickup device for use with an optical information medium according to the related art;

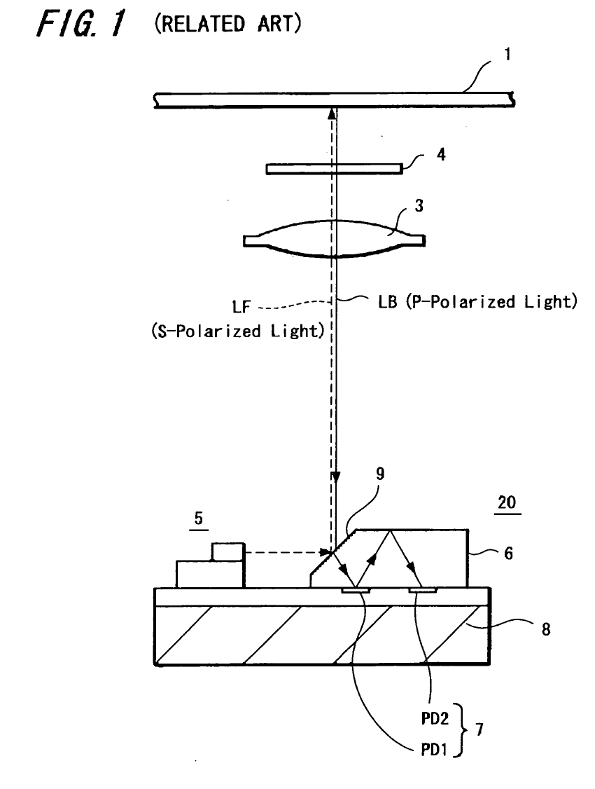

FIGS. 2A to 2D are diagrams useful for explaining patterns of photo-detecting elements, respectively;

FIG. 3 is a diagram showing an arrangement of an example of an inventive optical pickup device using a laser coupler device according to the present invention;

FIGS. 4A to 4C are diagrams to which reference will be made in explaining functions of a polarizing hologram for use with the present invention, respectively; and

FIG. 5 is a diagram of tables useful for explaining effects achieved by the laser coupler device according to the present invention.

### DESCRIPTION OF THE PREFERRED EMBODIMENTS

Embodiments of an integrated type light-emitting and light-receiving element, an optical pickup device for use with an optical information medium using such an integrated type light-emitting and light-receiving element and an optical disc apparatus using such an integrated type light-emitting and light-receiving element according to the present invention will now be described in detail. However, it is needless to say that the present invention is not limited to those embodiments.

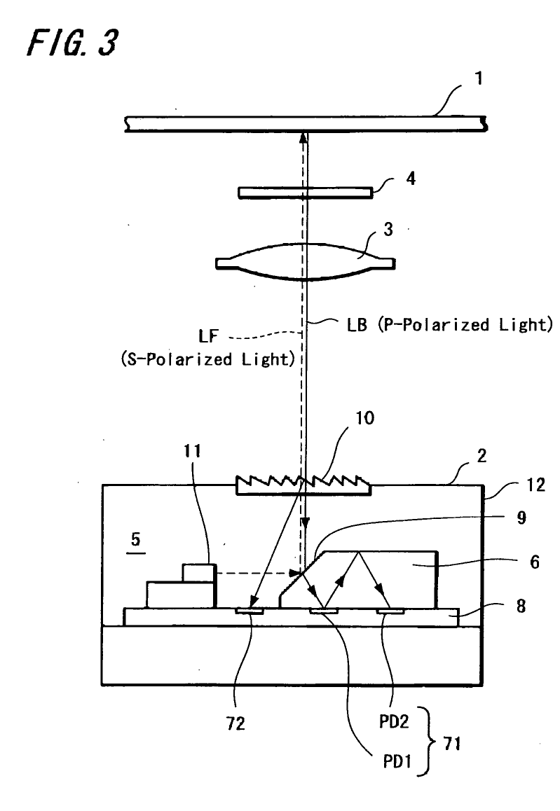

FIG. 3 is a schematic diagram of an arrangement showing a laser coupler 2 and a main portion of a reproducing system of an optical pickup device for use with an optical information medium and which is constructed by using this laser coupler 2, the optical pickup device being incorporated within the optical disc apparatus according to the first embodiment of the present invention.

In this case, the optical pickup device comprises the laser coupler 2 including a polarizing hologram 10, an objective lens 3 and a polarizing optical system consisting of a quarter-wave plate 4, for example, and the like in order to illuminate the optical information medium 1 such as CD, DVD and BD mounted on the mount portion (not shown) of the optical disc apparatus, for example, with laser light.

Then, illumination laser light LF of first polarized light of S-wave or P-wave emitted from the laser coupler 2 is converted into circularly-polarized light by the quarter-wave plate 4 and it is irradiated on the optical information medium 1 by the objective lens 3. Then, when the laser light LF is reflected on the optical information medium 1, its direction of polarization is rotated and inverted. Returned light LB of the laser light LF is again traveled through the quarter-wave plate 4 and thereby converted into second polarized light of P-wave or S-wave whose plane of polarization is perpendicular to that of first polarized light and thereby returned to the laser coupler 2.

As shown in FIG. 3, the laser coupler 2 is composed of a light source unit 5 for irradiating the optical information medium 1 with illumination laser light LF, a micro-prism 6, at least first and second photo-detecting units 71 and 72 and the polarizing hologram 10.

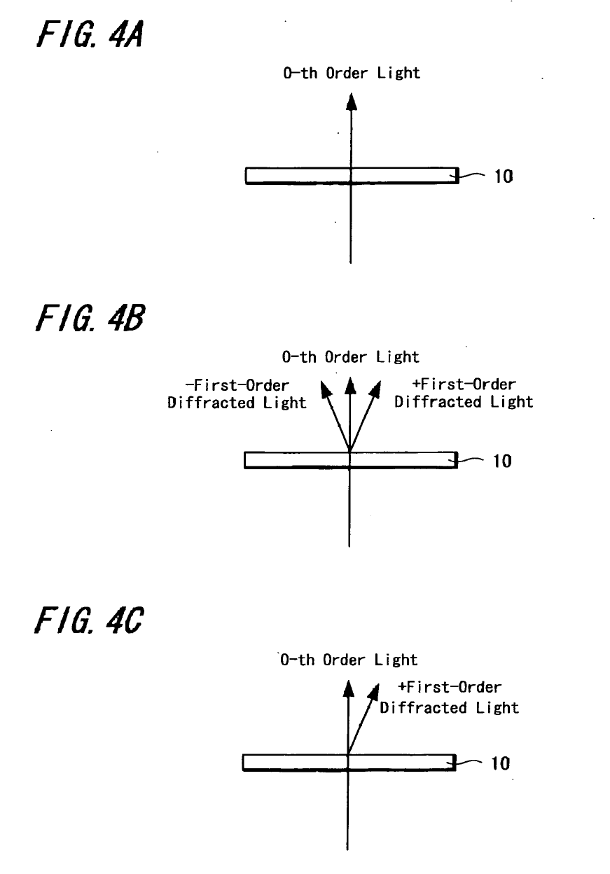

FIGS. 4A to 4C are diagrams schematically showing functions of the polarizing hologram 10. The polarizing hologram 10 passes first predetermined polarized light of S-wave or P-wave without causing diffracted light as shown in FIG. 4A. The polarizing hologram 10 generates diffracted light with respect to second polarized light of which plane of polarization is perpendicular to that of the first polarized light as shown in FIG. 4B. On the other hand, it is known well that any of a transmission type or reflection type blazed polarizing hologram with a sawtooth-like cross-section is able to generate only one of + (positive) or − (negative) diffracted light as shown in FIG. 4C. FIGS. 4A to 4C show only zero-th order light and first-order diffracted light of low order. Although diffracted lights of greater than second-order diffracted light also are generated, their quantities of lights are extremely small as compared with that of the first-order diffracted light.

When the above-mentioned polarizing hologram 10 is in use, the illumination laser light LF of the first linearly-polarized light of S-wave or P-wave emitted from the laser coupler 2 is passed through the polarizing hologram 10 without generating diffracted light and the returned light LB reflected on the optical information medium 1 generates diffracted light and it is passed through the polarizing hologram 10.

In the present invention, it is desirable that the blazed polarizing hologram should be used as the polarizing hologram 10 (see Japanese laid-open patent application No. 4-212730 with respect to this blazed polarizing hologram).

Also, as shown in FIG. 3, this polarizing hologram 10 may be located at the window portion which serves as a laser light path through which laser light can be introduced into and it is emitted from the package 12 of the laser coupler 2. Alternatively, the polarizing hologram 10 can be located at the outside or inside of the package 12. Also, the position at which the polarizing hologram 10 is located may be selected depending on whether the polarizing hologram is the reflection type hologram or the transmission type hologram.

When the optical information medium 1 is limited to any one of CD, DVD and BD, the light source unit 5 may be a light source which generates light of one kind of wavelength. When a plurality of kinds of optical information mediums is used selectively, the light source unit 5 may be a light source which generates first polarized light of S-wave or P-wave with a plurality of wavelengths, for example, more than two wavelengths. Then, a light source of the light source unit 5 can be formed of a semiconductor laser 11, for example.

The micro-prism 6 includes an inclined polarized light reflecting face 9 capable of efficiently reflecting the optical information medium illumination light LF of the first linearly-polarized laser light of S-polarized light or P-polarized light from the light source unit 5 and which can efficiently pass incident light of returned light of second linearly-polarized light of P-polarized light or S-polarized light different from this linearly-polarized laser light LF.

This inclined polarized light reflecting face 9 is formed on the inclined surface with an inclination angle of 45 degrees relative to the incident optical axis of laser light emitted from the light source unit 5. The illumination light LF reflected by this inclined polarized light reflecting face 9 is passed through the polarizing hologram 10 and it is further traveled toward the light path of the optical system such as the above-mentioned quarter-wave plate 4, objective lens 3 and the like.

Further, although the returned light of the second polarized light of P-polarized light or S-polarized light from the optical information medium 1 is passed through the polarizing hologram 10 and thereby diffracted light is generated, the zero-th light of the diffracted light is introduced into the micro-prism 6 through the inclined polarized light reflecting face 9.

At that time, first-order diffracted light L1 from the inclined polarized light reflecting face 9 is traveled toward other optical elements than the inclined polarized light reflecting face 9 of the micro-prism 6.

As a specific example of the inclined polarized light reflecting face 9, the inclined polarized light reflecting face 9 of the micro-prism 6 is comprised of a reflecting face capable of reflecting more than 50% of S-polarized laser light and which can pass at least more than 70% of P-polarized laser light.

More specifically, while the first linearly-polarized laser light LF of S-polarized light is emitted from the light source unit 5 and more than 50% of the first linearly-polarized laser light LF of S-polarized light is reflected on the inclined polarized light reflecting face 9 of the micro-prism 6, considering a utilization factor of laser, it is desired that this reflectance of the inclined polarized light reflecting face 9 should become as high as possible.

Also, the returned light LB from the optical information medium 1 is reflected on the optical information medium 1 and thereby its direction of polarization is rotated so that at least more than 70% of laser light of P-polarized light is passed through the inclined polarized light reflecting face 9. When the returned light LB is detected stably, transmittance of more than 90% may be practical, and it is desired that this transmittance should become as high as possible.

As shown in FIG. 3, first and second photo-detecting units 71 and 72 are formed as a part of the semiconductor integrated circuit (IC) 8 formed on a semiconductor substrate such as Si (silicon substrate).

Then, the above-mentioned micro-prism 6 is located above the semiconductor integrated circuit 8 formed of the semiconductor substrate at its portion in which the first photo-detecting unit 71 is formed. The semiconductor laser 11 of the light source unit 5 is mounted on this micro-prism 6 at its position at which the micro-prism 6 is opposed to the inclined polarized light reflecting face 9.

The first photo-detecting unit 71 is composed of first and second photo-detecting element units PD1 and PD2 formed of photo-diodes with a predetermined space therebetween.

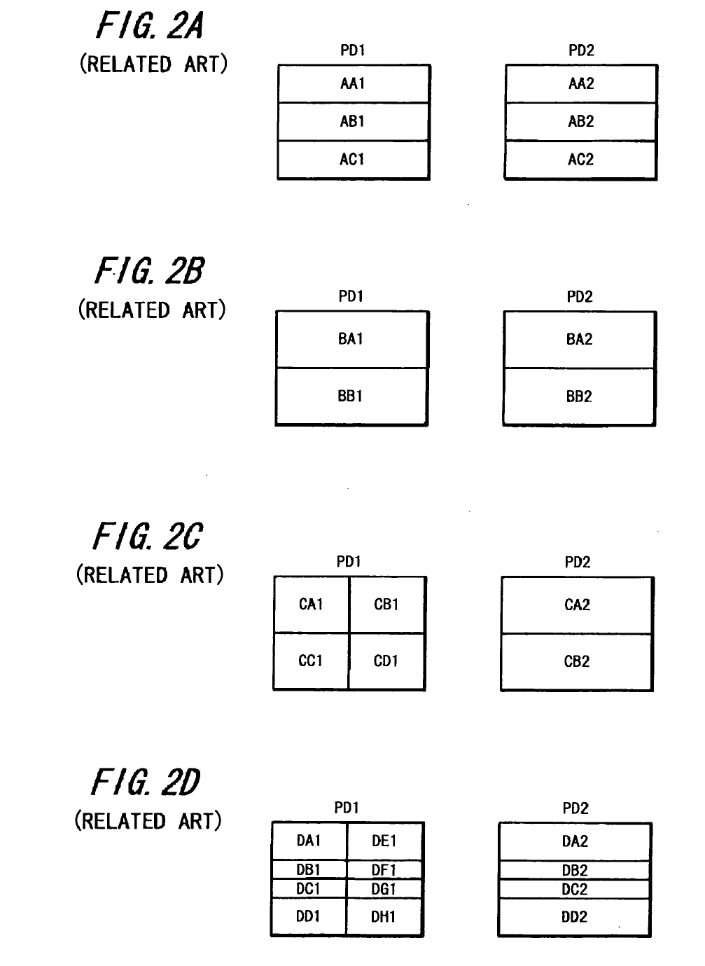

The first and second photo-detecting element units PD1 and PD2 comprise 8-divided elements DA1 to DH1 and 4-divided arrangement elements DA2 to DD2 shown in FIG. 2D, for example, respectively.

Then, a part of the returned light LB introduced from the inclined polarized light reflecting face 9 of the micro-prism 6 is converted into an electric signal by the first photo-detecting element unit PD1 and thereby detected. A rest of light is reflected by the micro-prism 6 at its upper face on the opposite side of the side in which the first photo-detecting unit 71 is located and it is introduced into the second photo-detecting unit 72, in which it is converted into an electric signal and thereby detected. Target tracking error signal and focusing error signal can be obtained by calculating these outputs. Then, the tracking servo signal and the focusing servo signal may be obtained based on the target tracking error signal and focusing error signal and thereby servo signals for controlling an actuator (not shown) of the objective lens 3, for example of an optical information pickup device can be obtained. Thus, tracking control and focusing control can be carried out by a well-known ordinary method.

The second photo-detecting unit 72 is located at the portion irradiated with first-order diffracted light from the above-mentioned polarizing hologram 10 and it is composed of a single photo-diode, for example. Then, data information may be read out from the optical information medium 1 by the second photo-detecting unit 72 which has the arrangement different from that of the first photo-detecting unit 71. Specifically, according to this arrangement, only the electric signal outputted from the second photo-detecting unit 72 after laser light has been received is amplified by the amplifier and thereby a high frequency information signal (RF signal) may be obtained.

Then, according to this arrangement, when the polarizing hologram 10 is formed of the blazed polarizing hologram which has been described so far with reference to FIG. 4C, it is possible to increase a quantity of light of the first-order diffracted light introduced into the second photo-detecting unit 72.

As described above, according to the arrangement of the present invention, since the RF information signal (high frequency information signal) is detected by the second photo-detecting unit 72 which is formed independently of the first photo-detecting unit 71 to detect the tracking error signal and the focusing error signal to obtain the control signal, introduction of a large noise can be avoided unlike the related-art case in which the RF information signal is obtained by signals from a large number of amplifiers and hence it is possible to improve an S/N (C/N).

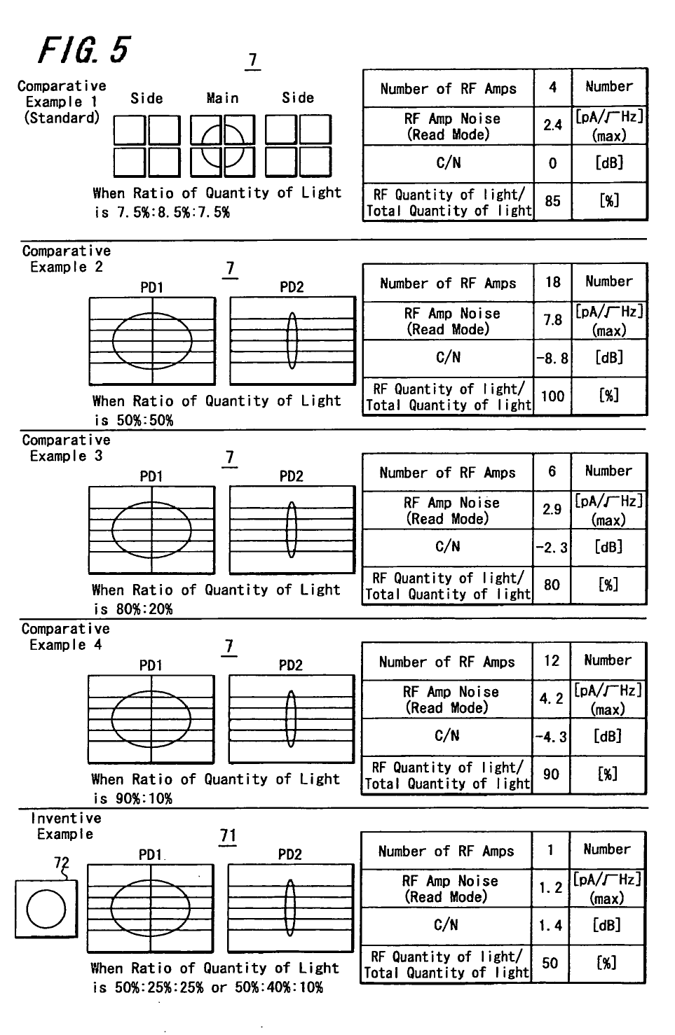

FIG. 5 illustrates arrangements of various kinds of photo-detecting portions of comparative examples 1 to 4 and an arrangement of an inventive example in contrast with C/N.

In the comparative example 1, a photo-detecting unit is composed of a main (Main) element having a quadrant photo-diode arrangement and side (Side) elements S, each of which has a quadrant photo-diode arrangement, located at both sides of the main element. With respect to ratios of quantity of light, 85% is distributed to the main element and 7.5% is distributed to the side elements located at both sides of the main element.

In the comparative examples 2 to 4, the first and second photo-detecting element units PD1 and PD2 of the photo-detecting unit 7 according to the related-art arrangement are composed of 12-divided photo-diode portions and 6-divided photo-diode portions. Then, the distribution ratios of quantity of light of the first and second photo-detecting element portions PD1 and PD2 are selected to be 50%:50% in the comparative example 2, they are selected to be 80%:20% in the comparative example 3 and they are selected to be 90%:10%, respectively.

Also, in the embodiment of the present invention, the second photo-detecting unit 72 formed of the single photo-diode is provided independently of the first photo-detecting unit 71 composed of the first and second photo-detecting element units PD1 and PD2. Then, with respect to the ratios of quantity of light, 50% is distributed to the second photo-detecting unit 72, 25% each are distributed to the first and second photo-detecting element units PD1 and PD2 of the first photo-detecting unit 71 or 40% is distributed to the first and second photo-detecting element units PD1 and PD2 of the first photo-detecting unit 71. C/Ns in the respective examples are shown on the tables of the right-hand side of FIG. 5 wherein C/N in the comparative example 1 is used as a reference value 0. Also, the number of amplifiers to obtain the RF signal, noises generated by the amplifiers and RF quantity of light/total quantity of light are shown on the respective tables on the right-hand side of FIG. 5.

As it is clear from FIG. 5, according to the embodiments of the present invention, amplifier noises can be improved and hence C/N can be also improved.

As described above, according to the present invention, there is provided the second photo-detecting unit 72 and this second photo-detecting unit 72 is formed on the same semiconductor substrate at the same time the first photo-detecting unit 71 is formed. Also, since the returned light which is to be introduced into the second photo-detecting unit 72 is simply obtained by the polarizing hologram, the arrangement of the second photo-detecting unit 72 can be prevented from becoming complex in particular.

Also, the arrangements of the integrated-type light-emitting and light-receiving element, the optical pickup device and the optical disc apparatus are not limited to the above-mentioned examples and it is needless to say that various modifications and variations are also possible in the arrangement of the optical system and the like. For example, although the zero-th order light from the polarizing hologram 10 is introduced into the micro-prism 6 and the first photo-detecting unit 71 while the first-diffracted light is detected by the second photo-detecting unit 72 and thereby the RF information signal can be obtained in the above-mentioned embodiments, the present invention is not limited thereto and various arrangements are also possible, in which the first-order diffracted light may be introduced into the micro-prism 6 and the zero-th light may be introduced into the second photo-detecting unit 72 and thereby the RF information signal can be obtained.

Further, the polarizing hologram 10 can be formed as the reflection type polarizing hologram by selecting its light path.

The above-mentioned integrated type light-emitting and light-receiving element according to the present invention can detect light introduced into the prism and it includes the polarizing hologram to generate diffracted light in returned light of predetermined polarized light introduced into the prism so that light path separated from light other than light introduced into the prism, for example, zero-th order light.

As described above, since zero-th order light, for example, passed through the polarizing hologram is introduced through the inclined polarized light reflecting face of the prism into the prism, predetermined information is detected by the first photo-detecting unit, for example, and diffracted light generated by the polarizing hologram is independently detected by the second photo-detecting unit and thereby predetermined information can be obtained, information can be independently obtained by the first and second photo-detecting units, and hence predetermined information of low noise independent of the first photo-detecting unit can be detected from the second photo-detecting unit, for example.

Then, according to the optical pickup device using the above-mentioned integrated type light-emitting and light-receiving element according to the present invention, laser light of S-wave or P-wave from the integrated type light-emitting and light-receiving element is irradiated on the target optical information medium, for example, the optical disc. When P-wave or S-wave of the returned light is passed through the polarizing hologram, zero-th order light and first-order light are generated and one of the two lights, for example, zero-th order light is introduced through the inclined polarized light reflecting face through the prism and the information signal for controlling illumination of laser light on the optical information medium, for example, the focusing error signal and the tracking error signal can be obtained by the first photo-detecting unit.

Then, laser light of other light path generated by the polarizing hologram is received by the second photo-detecting unit, whereby the RF signal can be obtained independently of the above-mentioned focusing error signal and tracking error signal.

Accordingly, with respect to this RF signal, since its output is amplified by the single amplifier, even when the first photo-detecting unit, for example, includes a number of divided photo-diode portions, it is possible to decrease the noise of the aforementioned amplifier.

Therefore, even when the optical pickup device includes a large number of divided photo-diode portions in order to detect tracking error signals suitable for various kinds of optical information mediums as was already described with reference to FIGS. 2A to 2D, without being affected by the amplifier noises, it is possible to obtain the high frequency information signal, that is, RF signal with low noise, accordingly, whose S/N (C/N) can be improved.

Then, since the optical pickup device according to the present invention includes the blazed polarizing hologram as the polarizing hologram of the integrated type light-emitting and light-receiving element, only any one of positive (+) and negative (−) diffracted lights can be obtained and hence intensity of diffracted light can be increased. Accordingly, if diffracted light of low order, for example, zero-th order light from the blazed polarizing hologram is used, then light with sufficiently large quantity of light can be detected and hence it is possible to increase an amount of signal to be obtained.

It should be understood by those skilled in the art that various modifications, combinations, sub-combinations and alterations may occur depending on design requirements and other factors insofar as they are within the scope of the appended claims or the equivalents thereof.

1. An integrated type light-emitting and light-receiving element comprising:
a light source unit for emitting laser light of first linearly-polarized light of S-polarized wave or P-polarized wave;
a prism;
at least first and second laser light detecting units; and
a polarizing hologram, said first and second laser light detecting units and said polarizing hologram being integrated with each other as one body, wherein said prism has an inclined polarized light reflecting face for reflecting said first linearly-polarized laser light from said light source unit and which passes second linearly-polarized light of P-polarized wave or S-polarized wave different from said first linearly-polarized laser light, said polarizing hologram does not generate diffracted light for said first linearly-polarized laser light and which generates diffracted light for said second linearly-polarized laser light, any one of diffracted lights of zero-th order light and diffracted light of low-order greater than first-order is introduced through said prism into said first laser light detecting unit and the other is introduced into said second laser light detecting unit and thereby lights are detected.

2. The integrated type light-emitting and light-receiving element according to claim 1, wherein said first photo-detecting unit is a photo-detecting unit for generating a control signal to control illumination of said emitted laser light on an irradiated portion and said second photo-detecting unit is a photo-detecting unit for generating a high frequency information signal of returned light independently of said control signal.

3. The integrated type light-emitting and light-receiving element according to claim 1, wherein said first photo-detecting unit detects zero-th order light after said zero-th order light was introduced from said polarizing hologram into said prism and said second photo-detecting unit detects first-order diffracted light from said hologram.

4. The integrated type light-emitting and light-receiving element according to claim 1, wherein said polarizing hologram includes a blazed polarizing hologram.

5. The integrated type light-emitting and light-receiving hologram according to claim 1, wherein said first and second photo-detecting units are assembled into one semiconductor integrated circuit.

6. The integrated type light-emitting and light-receiving element according to claim 1, wherein said prism and said first and second laser light detecting units are located within a package, said polarizing hologram being located at the position serving as a light path through which laser light is introduced into and outputted from said package.

7. An optical pickup device for use with an optical information medium, comprising:
an objective lens;
an integrated type light-emitting and light-receiving element; and
a polarizing optical system for polarizing linearly-polarized laser light from said integrated type light-emitting and light-receiving element to provide different polarized lights depending on an inward path and an outward path of emitted light to and from said optical information medium, wherein said integrated type light-emitting and light-receiving element includes a light source unit for emitting first linearly-polarized light of S-wave or P-wave, a prism, first and second laser light detecting units and a polarizing program, said prism includes an inclined polarized light reflecting face for reflecting said first linearly-polarized laser light emitted from said light source unit and which passes incident light of second linearly-polarized light of polarized P-wave or S-wave different from said linearly-polarized laser light, said polarizing hologram is a polarizing hologram which does not generate diffracted light relative to said first linearly-polarized laser light and which generates diffracted light relative to said second linearly-polarized light of said inward path and said laser light detecting unit includes a first photo-detecting unit for detecting returned light of any of zero-th order light and diffracted light of low-order greater than first-order of said second linearly-polarized light from said polarizing hologram and which is introduced into said prism and a second photo-detecting unit disposed outside said prism for detecting low-order diffracted light greater than said first-order or zero-th order light from said polarizing hologram.

8. The optical pickup device for use with an optical information medium according to claim 7, wherein said first photo-detecting unit is a photo-detecting unit for generating a control signal to control irradiation of said emitted laser light on an irradiated portion and said second photo-detecting unit is a photo-detecting unit for generating a high frequency information signal of said returned light independently of said control signal.

9. The optical pickup device for use with an optical information medium according to claim 7, wherein said zero-th order light from said polarizing hologram is introduced into said prism and detected by said first photo-detecting unit and said first-order light from said polarizing hologram is detected by said second photo-detecting unit.

10. The optical pickup device for use with an optical information medium according to claim 7, wherein said polarizing hologram includes a blazed polarizing hologram.

11. The optical pickup device for use with an optical information medium according to claim 7, wherein said first and second photo-detecting units are assembled into one semiconductor integrated circuit.

12. The optical pickup device for use with an optical information medium according to claim 7, wherein said light source unit, said prism and said first and second laser light detecting units are located within a package and said polarizing hologram is located at the position serving as a light path through which laser light is introduced into and outputted from said package.

13. An optical disc apparatus comprising:
a mount portion in which an optical disc is mounted;
an objective lens;
an integrated type light-emitting and light-receiving element; and
a polarizing optical system for polarizing emitted light of linearly-polarized laser light from said integrated type light-emitting and light-receiving element to provide different polarized lights depending on an outward path and an inward path of emitted light to and from an optical information medium, wherein said integrated type light-emitting and light-receiving element includes a light source unit for emitting first linearly-polarized light of S-wave or P-wave, a prism, first and second laser light detecting units and a polarizing program, said prism includes an inclined polarized light reflecting face for reflecting said first linearly-polarized laser light emitted from said light source unit and which passes incident light of second linearly-polarized light of polarized P-wave or S-wave different from said linearly-polarized laser light;
said polarizing hologram is a polarizing hologram which does not generate diffracted light relative to said first linearly-polarized laser light and which generates diffracted light relative to said second linearly-polarized light of said inward path; and
said laser light detecting unit includes a first photo-detecting unit for detecting returned light of any of zero-th order light and diffracted light of low-order greater than first-order of said second linearly-polarized light from said polarizing hologram and which is introduced into said prism and a second photo-detecting unit disposed outside said prism for detecting low-order diffracted light greater than said first-order or zero-th order light from said polarizing hologram.

14. The optical disc apparatus according to claim 13, wherein said first photo-detecting unit is a photo-detecting unit for generating a control signal to control irradiation of said emitted laser light on an irradiated portion and said second photo-detecting unit is a photo-detecting unit for generating a high frequency information signal of said returned light independently of said control signal.

15. The optical disc apparatus according to claim 13, wherein said zero-th order light from said polarizing hologram is introduced into said prism and detected by said first photo-detecting unit and said first-order light from said polarizing hologram is detected by said second photo-detecting unit.

16. The optical disc apparatus according to claim 13, wherein said polarizing hologram includes a blazed polarizing hologram.

17. The optical disc apparatus according to claim 13, wherein said first and second photo-detecting units are assembled into one semiconductor integrated circuit.

18. The optical disc apparatus according to claim 13, wherein said light source unit, said prism and said first and second laser light detecting units are located within a package and said polarizing hologram is located at the position serving as a light path through which laser light is introduced into and outputted from said package.
